(19) United States
(12) Patent Application Publication
(10) Pub. No.: US 2018/0213447 A1
(43) Pub. Date: Jul. 26, 2018

(54) COMMUNICATION APPARATUS, CONTROL METHOD, AND STORAGE MEDIUM

(71) Applicant: CANON KABUSHIKI KAISHA, Tokyo (JP)

(72) Inventor: Tomoki Hiramatsu, Tokyo (JP)

(21) Appl. No.: 15/876,811

(22) Filed: Jan. 22, 2018

(30) Foreign Application Priority Data
Jan. 23, 2017 (JP) 2017-009775

(51) Int. Cl. H04W 36/00; H04W 36/32; H04W 36/30

(52) U.S. Cl. CPC H04W 36/0016; H04W 36/0083; H04W 36/0022; H04W 36/30; H04W 36/32

(57) ABSTRACT

A communication apparatus obtains information regarding a network measured by a different apparatus from the different apparatus, connects to the network related to the information based on the obtained information regarding the network, perform communication of data via the connected network, and, in a case where information regarding a second network is obtained while communication of data via a first network is performed, controls switching of connection based on a first time length required to complete communication when connection to the first network is continued and a second time length required to complete communication when connection is switched to the second network.

### BACKGROUND

### Field

The present disclosure relates to a technique for controlling establishment of connection of a communication apparatus.

### Description of the Related Art

Recently, many terminal devices, such as smart devices and digital cameras, include communication functions based on a wireless local area network (LAN) and perform transmission and reception of data via networks of the wireless LAN. Japanese Patent Application Laid-Open No. 2010-124308 describes a digital camera that searches for an access point (hereinbelow, referred to as “AP”) of the wireless LAN while moving, and when detecting an AP, connects to the AP and downloads data from a server. According to the technique described in Japanese Patent Application Laid-Open No. 2010-124308, when a user moves in a space in which many APs are installed, a digital camera owned by the user automatically switches a connection destination AP and can continue the wireless LAN communication.

If the terminal switches a connection destination AP, it can prolong a time length required to complete desired data communication depending on a network configuration and a communication condition of a switchover destination AP. Japanese Patent Application Laid-Open No. 2005-348375 describes a technique for determining whether to switch a connection form by estimating respective required times to complete communication when the connection form is switched and when not switched by a communication apparatus.

According to the method described in Japanese Patent Application Laid-Open No. 2005-348375, the communication apparatus can obtain network information from a different apparatus based on position information. However, the network information is information about a connectable area for each connection form, so that the communication apparatus cannot determine a connection destination by taking a communication speed actually attained into consideration. In addition, the communication apparatus can obtain information of a communication speed of each connection form using a communication medium included in the own apparatus. However, the communication apparatus needs to suspend at least communication by the relevant connection form to obtain the information. Accordingly, it is not easy for the communication apparatus to timely and efficiently establish connection with an appropriate AP.

### SUMMARY OF THE INVENTION

The present disclosure is directed a technique enabling a communication apparatus to timely and efficiently establish connection with a different appropriate apparatus.

A communication apparatus according to an embodiment of the present disclosure includes an obtainment unit configured to obtain information regarding a network measured by another apparatus from the another apparatus, a connection unit configured to connect to the network related to the information based on the information regarding the network obtained by the obtainment unit, a communication unit configured to perform communication of data via the network connected by the connection unit, and a control unit configured to, in a case where the obtainment unit obtains information regarding a second network while the communication unit performs communication of data via a first network, control switching of connection to the connection unit based on a first time length required to complete the communication in a case where connection to the first network is continued and a second time length required to complete the communication in a case where connection is switched to the second network.

Further features will become apparent from the following description of exemplary embodiments with reference to the attached drawings.

### BRIEF DESCRIPTION OF THE DRAWINGS

FIG. 1 illustrates an example of a configuration of a wireless communication system.

FIG. 2 is a block diagram illustrating an example of a configuration of a digital camera.

FIG. 3 is a block diagram illustrating an example of a configuration of a smart device.

FIG. 4 is a flowchart illustrating an example of a processing flow executed by the digital camera.

FIG. 5 is a flowchart illustrating an example of a flow of handover execution determination processing executed by the digital camera.

FIG. 6 is a flowchart illustrating an example of a processing flow executed by the smart device.

FIG. 7 is a flowchart illustrating an example of a flow of network information measurement processing executed by the smart device.

FIG. 8A is a sequence chart illustrating a flow of a first processing example executed by the wireless communication system.

FIG. 8B is a sequence chart illustrating a flow of the first processing example executed by the wireless communication system.

FIG. 9A is a sequence chart illustrating a flow of a second processing example executed by the wireless communication system.

FIG. 9B is a sequence chart illustrating a flow of the second processing example executed by the wireless communication system.

### DESCRIPTION OF THE EMBODIMENTS

Exemplary embodiments will be described below with reference to the attached drawings. The technical scope of the present disclosure is established by the scope of the appended claims, but not limited by each exemplary embodiment described below.

### (Configuration Example of Wireless Communication System)

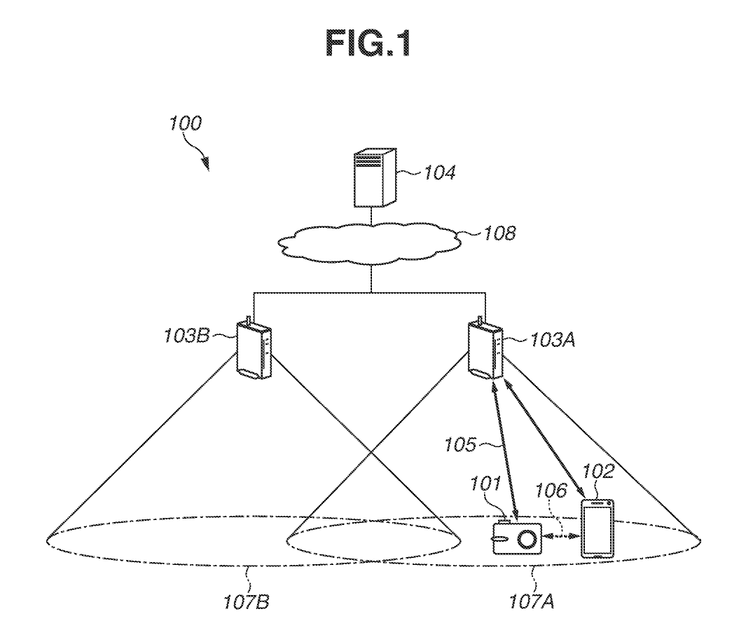

FIG. 1 illustrates an example of a configuration of a wireless communication system 100 according to the present exemplary embodiment. The wireless communication system 100 in FIG. 1 includes, for example, a digital camera 101, a smart device 102, access points (AP) 103A and 103B, and a server. Each of the digital camera 101, the smart device 102, and the APs 103A and 103B is a wireless communication apparatus including a communication function based on a wireless LAN. The APs 103A and 103B respectively establish wireless LAN networks 107A and 107B by infrastructure modes. The digital camera 101 and the smart device 102 connect to at least either of the networks 107A and 107B and can perform wireless communication via a signal 105 of the wireless LAN. The APs 103A and 103B and a server 104 are connected to a backbone network 108. The backbone network 108 is, for example, the Internet, however, can be another network, such as a local network. In addition, the digital camera 101 can perform communication using a signal 106 of Bluetooth® Low Energy between the smart device 102.

According to the present exemplary embodiment, the digital camera 101 can obtain network information regarding an AP to be a connection candidate from the smart device 102 via communication by Bluetooth Low Energy and perform a connection setting to the network. The smart device 102 can search for an AP that the device itself can connect, in other words an AP near the device itself, and notify the digital camera 101 of network information regarding the near AP as network information regarding a connection candidate AP.

According to the present exemplary embodiment, the digital camera 101 obtains the network information that the smart device 102 acquires by measurement and connects to the network 107A formed by the AP 103A based on the obtained network information. Subsequently, the digital camera 101 can move and connect to the network 107B formed by the AP 103B. At that time, the digital camera 101 obtains the network information that the smart device 102 separately acquires by measurement. The digital camera 101 estimates respective required times to complete desired data communication when a connection destination network is switched and when not switched based on the network information. When the required time to complete the desired data communication is shorter if the connection destination is not switched, the digital camera 101 continues communication without switching the connection destination network and switches the connection destination after the data communication is completed. When the required time to complete the desired data communication is shorter if the connection destination is switched, the digital camera 101 switches the connection destination network without waiting for completion of the data communication and continues the communication via a switchover destination network. The smart device 102 exists near the digital camera 101. Thus, the digital camera 101 can obtain communication quality that can be achieved when connecting to a network in which the smart device 102 exists by connecting to the network. Therefore, the digital camera 101 obtains the network information corresponding to measurement by the smart device 102 and thus, can accurately estimate required times to complete the communication when switching the connection destination and when not switching the connection destination. Accordingly, the digital camera 101 can timely and efficiently establish connection with an appropriate AP or perform handover to an appropriate AP. In addition, the digital camera 101 does not have to interrupt communication (for example, with the AP 103A) to obtain the network information at that time, and thus the wireless communication efficiency can be prevented from being deteriorated.

Configurations of the digital camera 101 and the smart device 102 that perform the above-described operations and processing executed by these apparatuses are described below. According to the present exemplary embodiment, the digital camera 101 performs processing for connecting to the wireless LAN network using Bluetooth Low Energy communication between the digital camera 101 and the smart device 102. However, the processing is not limited to this. For example, the processing can be used for the digital camera 101 to connect to a network different from the wireless LAN, and communication in a communication scheme other than Bluetooth Low Energy can be used in the present processing. The wireless LAN can conform to the Institute of Electrical and Electronics Engineers (IEEE) 802.11 standard series or another standard. In addition, another wireless medium, such as wireless universal serial bus (USB), MultiBand OFDM Alliance (MBOA), Bluetooth®, ultra-wideband (UWB), and ZigBee® can be used rather than the wireless LAN. UWB includes a wireless USB, wireless 1394, and WiMedia Network (WiNET). A wired communication medium, such as a wired LAN, can be used.

The digital camera 101 and the smart device 102 are examples of a communication apparatus for executing below-described processing, but any apparatus can be used as long as one communication apparatus can execute processing for connecting to a network in cooperation with the other communication apparatus. In other words, the digital camera 101 can be replaced with an arbitrary apparatus including a communication function, such as a laptop computer, a tablet terminal, a portable game machine, or a personal digital assistant (PDA). In addition, the smart device 102 can be similarly replaced with an arbitrary apparatus. For example, a function of the smart device 102 described below can be executed by the digital camera 101.

### (Configuration of Digital Camera)

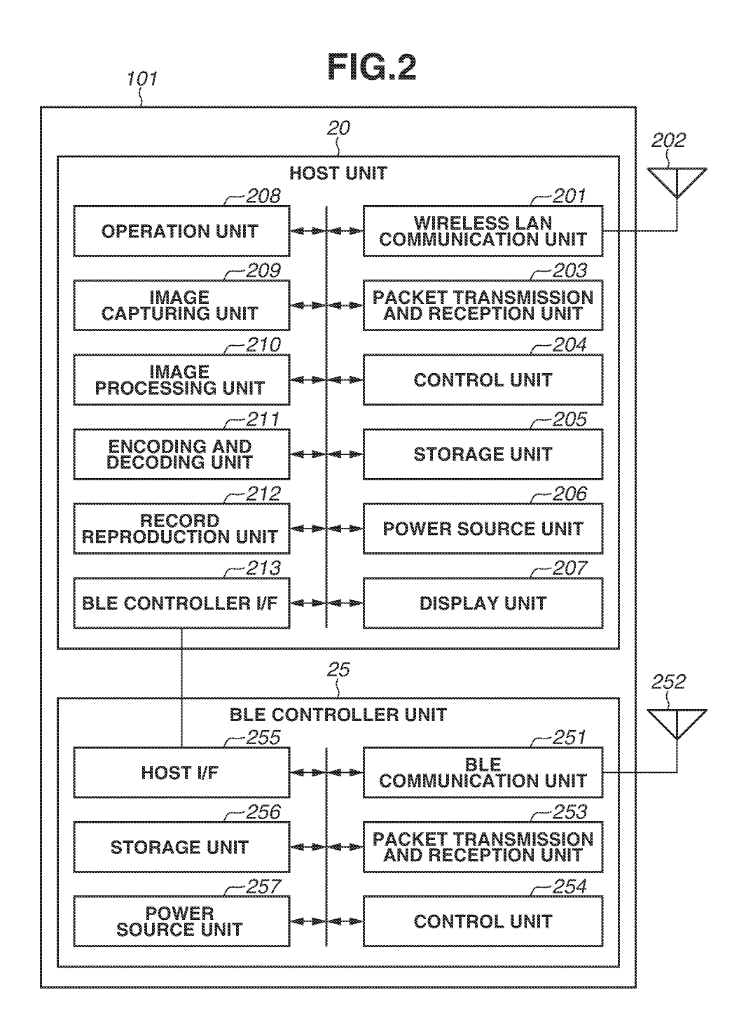

FIG. 2 illustrates an example of a configuration of the digital camera 101 according to the present exemplary embodiment. The digital camera 101 is includes, for example, a host unit 20 and a Bluetooth Low Energy controller unit 25. The host unit 20 and the Bluetooth Low Energy controller unit 25 respectively include, as a hardware configuration, a processor such as a central processing unit (CPU) and a microprocessing unit (MPU), a storage device such as a read only memory (ROM) and a random access memory (ROM), and a communication device such as an antenna and an amplifier. At least a part of each function unit described below can be realized by, for example, the processor reading and executing a program stored in the storage device. However, the relevant part can be realized by a different hardware.

The host unit 20 includes, for example, a wireless LAN communication unit 201, a packet transmission and reception unit 203, a control unit 204, a storage unit 205, a power source unit 206, a display unit 207, an operation unit 208, an image capturing unit 209, an image processing unit 210, an encoding and decoding unit 211, and a record reproduction unit 212. The host unit 20 also includes a Bluetooth Low Energy controller interface (I/F) 213 as an interface to the Bluetooth Low Energy controller unit 25.

The Bluetooth Low Energy controller unit 25 includes, for example, a Bluetooth Low Energy communication unit 251, a packet transmission and reception unit 253, a control unit 254, a storage unit 256, and a power source unit 257. The Bluetooth Low Energy controller unit 25 also includes a host I/F 255 as an interface to the host unit 20.

The wireless LAN communication unit 201 performs radio frequency (RF) control, communication processing, processing of a driver performing various types of control for communication conforming to IEEE 802.11 series, and processing of a related protocol of the wireless LAN. The wireless LAN communication unit 201 performs the wireless LAN communication via an antenna 202. The packet transmission and reception unit 203 transmits and receives packets related to various types of communication in the wireless LAN. The control unit 204 controls the host unit 20 by executing a control program stored in the storage unit 205. The storage unit 205 stores a control program executed by the control unit 204 and various information pieces such as a parameter necessary for communication. Various operations of the host unit 20 described below can be performed by the control unit 204 executing a control program stored in the storage unit 205.

The power source unit 206 supplies power to the host unit 20. The display unit 207 is a function unit, like a liquid crystal display (LCD) or a Light Emitting Diode (LED) display, that performs various types of display and can output visually recognizable information, and like a loudspeaker that outputs sound. The operation unit 208 receives an operation to the digital camera 101. The image capturing unit 209 captures an optical image of an object. The image processing unit 210 converts a captured image output from the image capturing unit 209 into image data in a predetermined format and executes various types of processing, such as luminance correction and color correction, of the image data. The encoding and decoding unit 211 performs predetermined high-efficiency encoding (for example, discrete cosine transform (DCT) and variable length coding after quantization) on the image data output from the image processing unit 210. The record reproduction unit 212 records and reproduces the compressed and encoded image data to a recording medium, which is not illustrated.

The Bluetooth Low Energy communication unit 251 performs RF control, communication processing, processing of a driver performing various types of control for communication conforming to standards, and processing of a related protocol of Bluetooth Low Energy. The Bluetooth Low Energy communication unit 251 performs Bluetooth Low Energy communication via an antenna 252. The packet transmission and reception unit 253 transmits and receives packets related to the Bluetooth Low Energy communication. The control unit 254 controls the Bluetooth Low Energy controller unit 25 by executing a control program stored in the storage unit 256. The storage unit 256 stores a control program executed by the control unit 254 and various information pieces, such as a parameter necessary for the Bluetooth Low Energy communication. Various operations of the Bluetooth Low Energy controller unit 25 described below can be performed by the control unit 254 executing a control program stored in the storage unit 256. The power source unit 257 supplies power to the Bluetooth Low Energy controller unit 25.

According to the present exemplary embodiment, the Bluetooth Low Energy controller unit 25 is configured as described above, and thus each of the Bluetooth Low Energy controller unit 25 and the host unit 20 can operate independently. In other words, the Bluetooth Low Energy controller unit 25 can be started up by the power supply from the power source unit 257 and communicate with an external apparatus by Bluetooth Low Energy if the power source unit 206 stops power supply to the host unit 20.

### (Configuration of Smart Device)

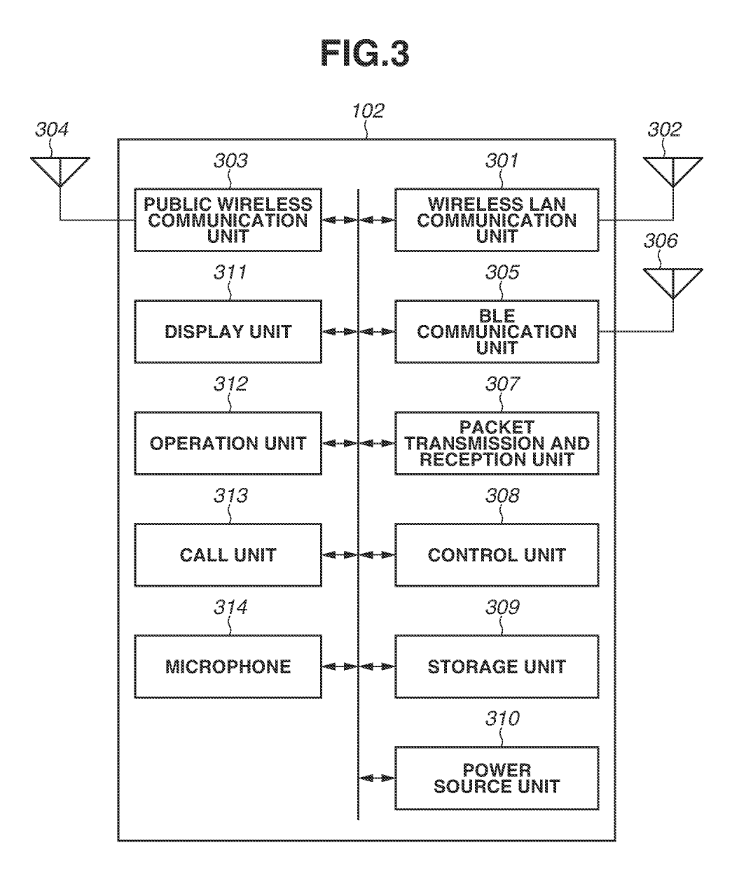

FIG. 3 illustrates an example of a configuration of the smart device 102 according to the present exemplary embodiment. The smart device 102 includes, for example, a wireless LAN communication unit 301, a public wireless communication unit 303, a Bluetooth Low Energy communication unit 305, a packet transmission and reception unit 307, a control unit 308, a storage unit 309, a power source unit 310, a display unit 311, an operation unit 312, a call unit 313, and a microphone 314.

The wireless LAN communication unit 301 performs RF control, communication processing, processing of a driver performing various types of control for communication conforming to IEEE 802.11 series, and processing of a related protocol of the wireless LAN. The wireless LAN communication unit 301 performs the wireless LAN communication via an antenna 302. The public wireless communication unit 303 performs RF control, communication processing, processing of a driver performing various types of control for communication conforming to standards, and processing of a related protocol of the public wireless communication. The public wireless communication can be communication conforming to, for example, International Multimedia Telecommunications (IMT) standards and Long Term Evolution (LTE) standards. The public wireless communication unit 303 performs communication via an antenna 304. The Bluetooth Low Energy communication unit 305 performs RF control, communication processing, processing of a driver performing various types of control for communication conforming to standards, and processing of a related protocol of Bluetooth Low Energy. The Bluetooth Low Energy communication unit 305 performs communication via an antenna 306. The packet transmission and reception unit 307 transmits and receives packets related to various types of communication. The control unit 308 controls the entire smart device 102 by executing a control program stored in the storage unit 309. The storage unit 309 stores a control program executed by the control unit 308 and various information pieces, such as a parameter necessary for communication. Various operations described below can be performed by the control unit 308 executing a control program stored in the storage unit 309. The power source unit 310 supplies power to the smart device 102. The display unit 311 is a function unit, like an LCD or LED, that performs various types of display and can output visually recognizable information and like a loudspeaker that outputs sound. The operation unit 312 receives an operation to the smart device 102. The call unit 313 provides a call function to a user via the microphone 314.

All of the above-described function blocks have mutual relations therebetween based on software and hardware. The above-described function blocks are examples, and a plurality of function blocks can constitute one function block, and any of the function blocks can be divided into a plurality of function blocks.

### (Processing Flow)

Processing executed by both the digital camera 101 and the smart device 102 is described below, and subsequently, examples of processing flows executed in the system in several situations are described. In the following description, identifier information of an AP that can be a connection destination candidate is registered in advance in the smart device 102. Identifier information can be a basic service set identifier (BSSID) and a communication channel of a network generated by an AP. However, the identifier information is not limited to them. For example, one or more of a service set identifier (SSID), an encryption method, an encryption key, and predetermined information with which a network can be identified can be used as the identifier information.

### ((Processing of Digital Camera))

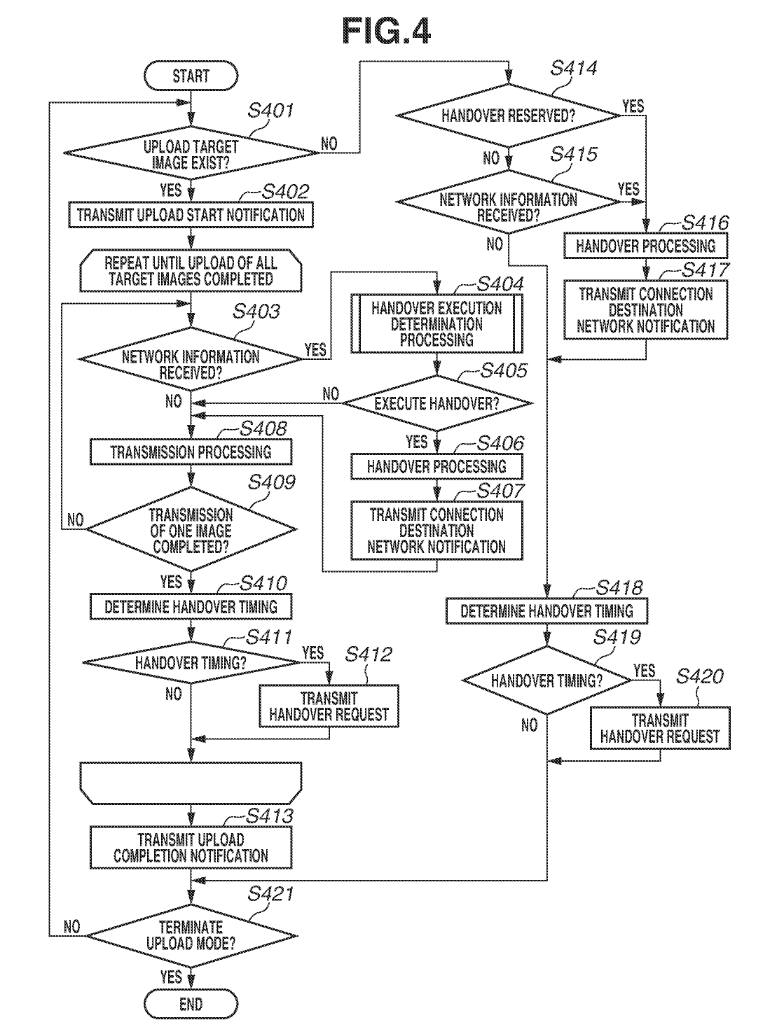

A processing flow executed by the digital camera 101 is described with reference to FIG. 4. FIG. 4 illustrates an example of a processing flow when the digital camera 101 operates in an upload mode for uploading temporarily stored data, such as a captured image, to the server 104. However, the present processing can be performed at the time of downloading without being limited to uploading of data. In other words, the present processing can be executed when the digital camera 101 is in a state to perform communication, and an operation mode of the digital camera 101 and the like is not especially limited. The present processing can be started, for example, via a button operation and menu selection by a user on the digital camera 101 as a trigger. However, the trigger is not limited to the button operation or menu selection. The digital camera 101 can start the present processing, for example, when detecting proximity of the smart device 102 via near field communication (NFC) and when being instructed to start by a predetermined signal from the smart device 102 by Bluetooth Low Energy.

Processing including the present processing executed by the digital camera 101 can be realized such that, for example, the control unit 204 executes a program stored in the storage unit 205 and control each function unit. However, at least a part of processing can be realized by a unit other than the control unit 204 in the digital camera 101, for example, processing related to Bluetooth Low Energy can be performed by the control unit 254 in the Bluetooth Low Energy controller unit 25 executing a program stored in the storage unit 256. The control unit 204 can control the processing related to Bluetooth Low Energy by transmitting an instruction to the Bluetooth Low Energy controller unit 25 via the Bluetooth Low Energy controller I/F 213.

In step S401, when starting the present processing, the digital camera 101 first determines whether an upload target image exists, namely whether it is necessary to perform communication. The upload target image can be image data that is not uploaded to the server 104 in the image data pieces captured and stored by the digital camera 101. However, the upload target image is not limited to this. For example, image data of which additional information is updated after the image data is uploaded to the server 104 and image data selected by a button operation by a user can be regarded as the upload target image. When the upload target image exists (YES in step S401), in step S402, the digital camera 101 transmits an upload start notification to the smart device 102. The upload start notification is a signal notifying a start of upload processing by the digital camera 101 and can be transmitted via, for example, Bluetooth Low Energy communication.

Subsequently, the digital camera 101 repeatedly executes processing in steps S403 to S412 on all of the upload target images. More specifically, in step S403, the digital camera 101 first determines whether the network information is received from the smart device 102 (for example, via the Bluetooth Low Energy communication). The network information is information indicating one or more of, for example, the identifier information, a throughput, radio field intensity, necessity of address obtainment processing, necessity of authentication processing, and necessity for establishing a communication session of the network generated by the AP. However, the network information is not limited to the above-mentioned information pieces and can include information indicating one or more of, for example, a data rate, a delay time, a retransmission probability, a packet loss rate, and the number of connecting terminals of the network generated by the AP. The network information is information obtained by measuring an actual environment by the smart device 102. In this regard, the smart device 102 and the digital camera 101 are adjacent to each other, so that it is expected that the digital camera 101 can obtain an environment similar to that of the network information obtained by the smart device 102.

When the network information is received (YES in step S403), the digital camera 101 advances the processing to step S404. When the network information is not received (NO in step S403), the digital camera 101 advances the processing to step S408. In step S404, the digital camera 101 starts handover execution determination processing for determining whether to execute handover at this point in time. The handover represents processing for switching a connection destination network. The handover processing according to the present exemplary embodiment can be processing for establishing new wireless connection to a network generated by a handover destination AP after disconnecting wireless connection to a network generated by a currently connecting AP. However, the handover processing is not limited to this. For example, the digital camera 101 can disconnect a communication session between the server 104 and release an address being used before disconnecting the wireless connection with the network of the currently connecting AP based on the network information obtained from the smart device 102. In addition, the digital camera 101 can establish a communication session between the server 104 and perform authentication processing and address acquisition after establishing the new wireless connection. As described above, the digital camera 101 executes only necessary handover processing based on the network information obtained from the smart device 102 and thus can shorten a time required to switch a connection destination network.

The handover execution determination processing is described in detail below. When it is determined to execute the handover processing by the handover execution determination processing (YES in step S405), in step S406, the digital camera 101 executes the handover processing. Subsequently, in step S407, the digital camera 101 transmits a connection destination network notification to the smart device 102 (for example, via the Bluetooth Low Energy communication) and advances the processing to step S408. The connection destination network notification in step S407 is a signal that the digital camera 101 notifies of the identifier information of the currently connecting AP. When it is determined not to execute the handover processing by the handover execution determination processing (NO in step S405), the digital camera 101 advances the processing to step S408 without performing the processing in steps S406 and step S407.

In step S408, the digital camera 101 transmits a transmission target image and, in step S409, determines whether transmission of one image is completed. According to the present exemplary embodiment, the digital camera 101 can perform the transmission processing by dividing and transmitting image data to the server 104 using a file transfer protocol (FTP). However, the transmission processing is not limited to this. For example, other protocols, such as a HyperText Transfer Protocol (HTTP), a Transmission Control Protocol (TCP), and a User Datagram Protocol (UDP), can be used. The image data can be transmitted in one image in one transmission without being divided, and in this case, the determination in step S409 can be omitted. When it is determined that transmission of one image is completed (YES in step S409), the digital camera 101 advances the processing to step S410, whereas, when it is determined that transmission of one image is not completed (NO in step S409), the processing is returned to step S403. In other words, the processing in steps S403 to S408 is repeated by the transmission, and, for example, when it is appropriate to execute handover even one image is being transmitted, the handover processing can be executed.

In step S410, the digital camera 101 determines whether a current communication situation is a situation providing a handover timing. The determination of a handover timing can be performed by determining whether a data transmission throughput to the server 104 via the currently connecting AP becomes less than or equal to a threshold value. In other words, the digital camera 101 can determine that the current situation is a situation providing the handover timing when the data transmission throughput to the server 104 via the currently connecting AP becomes less than or equal to the threshold value. The data transmission throughput to the server 104 via the currently connecting AP can be calculated from a data size transmitted by transmission processing and a time length required to the relevant transmission processing. However, such a throughput can be calculated based on, for example, the network information received from the smart device 102 without being limited to the above-described one. In addition, an index other than the throughput can be used in the determination of the handover timing, and the determination can be performed by, for example, whether the radio field intensity and the data rate becomes less than or equal to a threshold value and whether the retransmission probability and the delay time becomes greater than or equal to a threshold value.

When the situation is determined as the one providing the handover timing (YES in step S411), in step S412, the digital camera 101 transmits a handover request to the smart device 102 (for example, via the Bluetooth Low Energy communication). The handover request is a signal notifying that the situation of the digital camera 101 is the situation providing the handover timing. The handover request can include a factor of determining as the handover timing and the network information of the currently connecting AP, however, the handover request is not limited to this. These information pieces may not be included therein, for example, when the smart device 102 recognizes the currently connecting AP. When the situation is determined as the one not providing the handover timing (NO in step S411), the digital camera 101 executes the processing in steps S403 to S412 on a different upload target image data. The digital camera 101 repeatedly executes the processing in steps S403 to S412 on all of the upload target image data pieces and then advances the processing to step S413. In step S413, the digital camera 101 transmits an upload completion notification to the smart device 102 (for example, via the Bluetooth Low Energy communication) and advances the processing to step S421. The upload completion notification is a signal notifying completion of the upload processing by the digital camera 101.

In step S421, the digital camera 101 determines whether to terminate the upload mode. When terminating the upload mode (YES in step S421), the digital camera 101 terminates the present processing, whereas when not terminating the upload mode (NO in step S421), the digital camera 101 returns the processing to step S401. A button operation and menu selection by a user on the digital camera 101 can be a trigger to terminate the upload mode. The trigger, however, is not limited to this. For example, the digital camera 101 can terminate the upload mode in response to receiving an instruction to terminate the upload mode from the smart device 102 via the Bluetooth Low Energy communication. In addition, the digital camera 101 can terminate the upload mode when a battery remaining amount becomes less than or equal to a threshold value and if the upload target image does not exist for a predetermined time period.

In step S401, when it is determined that the upload target image does not exist (NO in step S401), in step S414, the digital camera 101 determines whether handover is reserved. The digital camera 101 reserves the handover when determining, in the handover execution determination processing in step S404, not to execute the handover at that time point and execute the handover after terminating the upload processing. The processing is described in detail below. When the handover is reserved (YES in step S414), in step S416, the digital camera 101 executes the handover processing and, in step S417, transmits the connection destination network notification to the smart device 102. When the handover is not reserved (NO in step S414), in step S415, the digital camera 101 determines whether the network information is received from the smart device 102 (for example, via the Bluetooth Low Energy communication). When the network information is received (YES in step S415), in step S416, the digital camera 101 executes the handover processing and, in step S417, transmits the connection destination network notification to the smart device 102. In other words, the digital camera 101 is not uploading data in this step, and thus executes the handover processing without performing the handover execution determination processing. The processing in steps S416 and S417 is respectively similar to the processing in steps S406 and S407. Subsequently, in steps S418 to S420, the digital camera 101 executes the processing similar to those in steps S410 to S412, and then advances the processing to step S421.

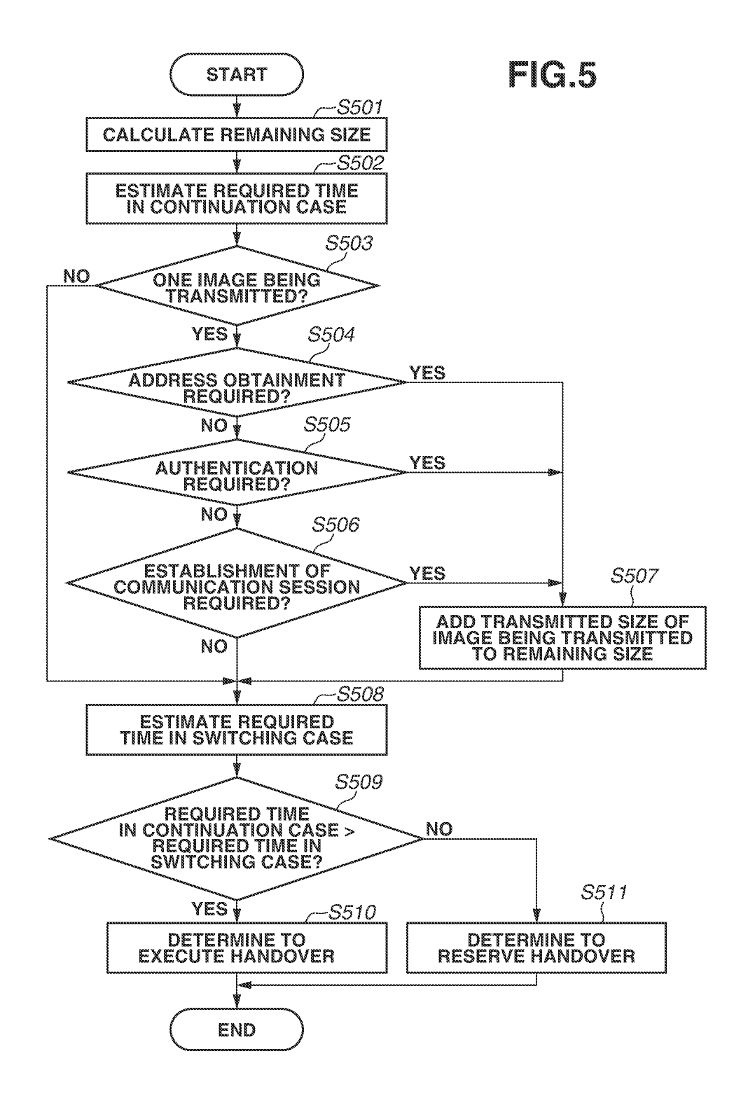

A flow of the handover execution determination processing executed by the digital camera 101 is described with reference to FIG. 5. The present processing can be executed when the upload target image data exists at least in the digital camera 101 (YES in step S401), and the network information is received from the smart device 102 (YES in step S403) as described above.

According to the present processing, in step S501, the digital camera 101 first calculates a size of data that is not transmitted in the upload target image data pieces. The size can be calculated as a remaining size obtained by subtracting a size of data of which transmission to the server 104 is completed from a total size of the entire upload target image data pieces. Next, in step S502, the digital camera 101 estimates a time length (hereinbelow, referred to as “a required time in the continuation case”) required to complete upload of the data having the calculated remaining size when the communication is continued using the currently connecting AP. According to the present exemplary embodiment, the required time in the continuation case can be estimated by, for example, dividing the remaining size by a throughput using the calculated remaining size and the data transmission throughput to the server 104 via the currently connecting AP. The estimation method, however, is not limited to this. For example, the required time in the continuation case can be estimated using radio field intensity and a data rate of the currently connecting AP or using the network information received from the smart device 102. For example, the required time in the continuation case can be calculated by calculating an available communication speed from the radio field intensity of the currently connecting AP and dividing the remaining size by the calculation result.

Next, in step S503, the digital camera 101 determines whether one image is in the middle of being transmitted. When one image is in the middle of being transmitted (YES in step S503), in step S504, the digital camera 101 determines whether the address obtainment processing is required to be executed when the handover processing is executed. When it is determined that the address obtainment processing is required to be executed (YES in step S504), the digital camera 101 advances the processing to step S507. When it is determined that the address obtainment processing is not required to be executed (NO in step S504), the digital camera 101 advances the processing to step S505. The address obtainment processing can be executed based on, for example, dynamic host configuration protocol (DHCP) and Automatic Private IP Addressing (AutoIP). However, the address obtainment processing can be executed by a method other than the above-described ones. In step S505, the digital camera 101 determines whether the authentication processing is required to be executed when the handover processing is executed. When it is determined that the authentication processing is required to be executed (YES in step S505), the digital camera 101 advances the processing to step S507. When it is determined that the authentication processing is not required to be executed (NO in step S505), the digital camera 101 advances the processing to step S506. In step S506, the digital camera 101 determines whether the processing for establishing the communication session with the server 104 is required to be executed. When it is determined that the processing for establishing the communication session is required to be executed (YES in step S506), the digital camera 101 advances the processing to step S507. When it is determined that the processing for establishing the communication session is not required to be executed (NO in step S506), the digital camera 101 advances the processing to step S508. According to the present exemplary embodiment, the communication session can be an FTP communication session used for uploading. However, communication sessions of other communication protocols, such as HTTP, TCP, and UDP can be used without being limited to the above-described one. Determination in steps S504 to S506 is executed based on the network information received from the smart device 102. Accordingly, the digital camera 101 can understand in advance the processing to be executed when executing the handover processing without connecting to the handover destination AP.

In step S507, the digital camera 101 needs to transmit the image data in the middle of being transmitted again from the beginning by a network of the handover destination. Thus, the digital camera 101 adds a size of data that is an already transmitted portion in the one image in the middle of being transmitted to the remaining size calculated in step S501 and advances the processing to step S508. Accordingly, the digital camera 101 can change the remaining size of the transmission target data used for estimating a required time in the switching case in response to the processing to be executed when executing the handover processing and thus accurately estimate the required time in the switching case.

In step S503, when one image is not in the middle of being transmitted (NO in step S503), the digital camera 101 advances the processing to step S508 without executing the processing in steps S504 to S507.

In step S508, the digital camera 101 estimates a time length (hereinbelow, referred to as “the required time in the switching case”) required to complete upload of the data having the size calculated in step S502 or S507 when the communication is performed using the handover destination AP. The required time in the switching case can be estimated using the size of the data calculated in step S502 or S507 and the data transmission throughput to the server 104 via the handover destination AP included in the network information received from the smart device 102. However, the required time in the switching case can be estimated using, for example, radio field intensity and a data rate of the handover destination AP included in the network information received from the smart device 102 without being limited to the above-described one. In addition, to the required time in the switching case, a time length required to the processing for address obtainment, authentication, and establishment of the communication session estimated based on the network information received from the smart device 102 can be added. For example, the required time in the switching case can be calculated as follows:

Required time in switching case=(remaining size/throughput)+(address obtainment processing time)+(authentication processing time)+(communication session establishment processing)

Then, in step S509, the digital camera 101 determines whether the required time in the continuation case is greater than the required time in the switching case. When the required time in the continuation case is greater than the required time in the switching case (YES in step S509), in step S510, the digital camera 101 determines to execute the handover at that time point and terminates the processing. When the required time in the continuation case is less than or equal to the required time in the switching case (NO in step S509), in step S511, the digital camera 101 determines not to execute the handover at that time point. In other words, the digital camera 101 determines to reserve the handover and terminates the processing.

As described above, the digital camera 101 obtains the network information that is obtained as a result of that the smart device 102 measuring an actual environment. The digital camera 101 compares the required time in the switching case and the required time in the continuation case, which are accurately estimated based on the obtained network information. Accordingly, the digital camera 101 can appropriately determine whether to execute the handover at that time point or to reserve the handover without executing it at that time point. Therefore, the digital camera 101 can avoid switching of connection at an inappropriate timing and perform communication using the wireless LAN at high speed.

### ((Processing of Smart Device))

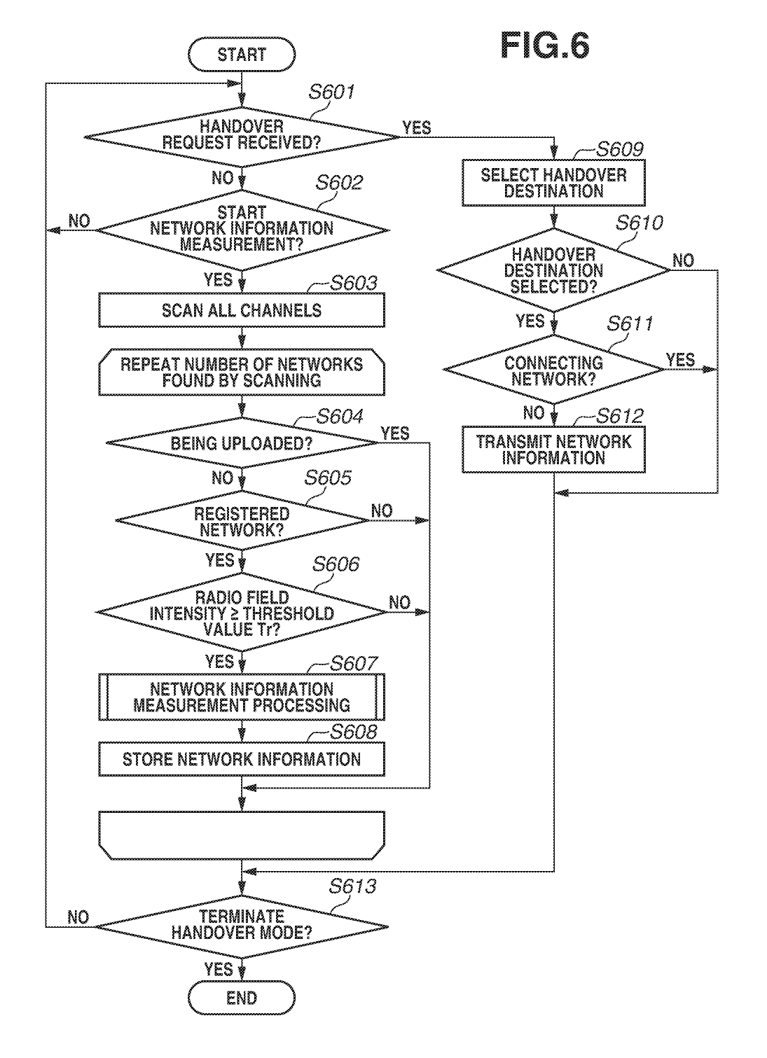

A processing flow executed by the smart device 102 will now be described. FIG. 6 illustrates an example of a processing flow executed by the smart device 102 during an operation in a handover mode for supporting the handover (network connection) processing by the digital camera 101. A trigger for starting the present processing can be, for example, start-up of an application and a button operation by a user on the smart device 102. However, the trigger is not limited to this. For example, the smart device 102 can automatically start the present processing based on receipt of a processing start notification from the digital camera 101 via the Bluetooth Low Energy communication and start-up of an operation system (OS).

In the present processing, in step S601, the smart device 102 first determines whether a handover request is received from the digital camera 101. When the handover request is received (YES in step S601), the smart device 102 advances the processing to step S609. When the handover request is not received (NO in step S601), the smart device 102 advances the processing to step S602. In step S602, the smart device 102 determines whether to start network information measurement. Determination of whether to start the network information measurement can be performed based on, for example, an elapsed time from a time point when the last network information measurement is executed. For example, when a time longer than or equal to a predetermined time has elapsed from when the previous network information measurement is executed, the smart device 102 can determine to start the network information measurement in consideration of a possibility that a surrounding environment has changed. The smart device 102 can determine to start the network information measurement based on, for example, a standard different from an elapsed time, such as whether to detect a movement of the smart device 102. For example, when the movement of the smart device 102 is detected, the smart device 102 determines that a surrounding network is highly likely to be changed and can determine to start the network information measurement. When the network information measurement is not started (NO in step S602), the smart device 102 returns the processing to step S601.

When it is determined that the network information measurement is started (YES in step S602), in step S603, the smart device 102 searches (scans) the surrounding network in all communication channels. While, as described above, that scanning is executed in the all communication channels, the scanning can, for example, be executed only in a part of channels corresponding to a network stored in advance. This enables shortening a time required for scanning. In association with this processing, for example, when data communication by the wireless LAN of another application is being executed, the smart device 102 can quicken a return to the data communication from scanning and thus suppress degradation of throughput.

The smart device 102 then executes processing in steps S604 to S608 for measuring the network information with respect to each network detected in step S603. In step S604, the smart device 102 first determines whether a target network is a network in which the digital camera 101 is uploading data. The smart device 102 can determine whether the target network is the network in which the digital camera 101 is uploading data based on the connection destination network notification, the upload start notification, and the upload completion notification received from the digital camera 101. For example, the smart device 102 determines whether the identifier information included in the connection destination network notification matches with the identifier information of the target network. When the identifier information pieces match with each other, the smart device 102 determines whether it is a timing after receiving the upload start notification and before receiving the upload completion notification. When the identifier information pieces match with each other, and the timing is after receiving the upload start notification and before receiving the upload completion notification, the smart device 102 determines that the target network is the network in which the digital camera 101 is uploading data. The smart device 102 can, for example, determine whether a signal is transmitted and received between the digital camera 101 and the connection destination AP by monitoring a header section of the received signal, and thus identify the network in which the digital camera 101 is uploading data. When the target network is the network in which the digital camera 101 is uploading data (YES in step S604), the smart device 102 does not execute the processing in steps S605 to S608, but rather executes the processing in steps S604 to S608 with respect to a next network. Accordingly, a communication load of the target network can be suppressed from increasing and degradation of throughput can be prevented in the digital camera 101. When the target network is not the network in which the digital camera 101 is uploading data (NO in step S604), in step S605, the smart device 102 determines whether the target network is a network already registered as a connection destination candidate. When the target network is registered as the connection destination candidate (YES in step S605), in step S606, the smart device 102 determines whether radio field intensity of the network is greater than or equal to a predetermined value (for example, greater than or equal to a threshold value Tr). When the radio field intensity is greater than or equal to the predetermined value (YES in step S606), in step S607, the smart device 102 executes the network information measurement processing. In step S608, the smart device 102 stores the information measured by the network information measurement processing. The network information measurement processing is described in detail below. When the target network is not registered as the connection destination candidate (NO in step S605) or when the radio field intensity is less than the predetermined value (NO in step S606), the smart device 102 determines that the target network is not a handover destination candidate network. Subsequently, the smart device 102 executes the processing in steps S604 to S608 with respect to the next network. The smart device 102 repeatedly executes the processing in steps S604 to S608 with respect to all of the networks found by the scanning in step S603, and then advances the processing to step S613.

In step S613, the smart device 102 determines whether to terminate the handover mode. When determining to terminate the handover mode (YES in step S613), the smart device 102 terminates the processing. When the smart device 102 determines not to terminate the processing (NO in step S613), the smart device 102 returns the processing to step S601. Termination of the application and button operation by a user can trigger the smart device 102 to determine to terminate the present processing. However the trigger is not limited to this. For example, a trigger for the smart device 102 to determine to terminate the processing can be lowering of a battery remaining amount of the smart device 102 or disconnection of a Bluetooth Low Energy communication link with the digital camera 101. Accordingly, the smart device 102 can suppress unnecessary power consumption.

When it is determined in step S601 that the handover request is received from the digital camera 101 (YES in step S601), in step S609, the smart device 102 selects the handover destination. In this step, for example, a network with highest throughput can be selected as the handover destination based on the network information stored as the result of the network information measurement. The network to be selected, however, is not limited to this. For example, a network of which a throughput is greater than or equal to a threshold value can be selected as the handover destination, and the handover destination network can be selected using the radio field intensity and the data rate. The handover destination network can also be selected from networks not requiring processing for address obtainment, authentication, and establishment of the communication session. In step S610, the smart device 102 determines whether the handover destination network is selected. When the handover destination network is selected (YES in step S610), in step S611, the smart device 102 determines that the network selected as the handover destination is identical to the network that the digital camera 101 is currently connecting to. When the handover destination network is not identical to the network that the digital camera 101 is currently connecting to (NO in step S611), in step S612, the smart device 102 transmits the network information regarding the handover destination network to the digital camera 101. The transmission of the network information is performed, for example, using Bluetooth Low Energy. When the handover destination network is not selected (NO in step S610), or when the handover destination network is identical to the network that the digital camera 101 is currently connecting to (YES in step S611), the smart device 102 does not perform the processing in step S612. The smart device 102 then advances the processing to step S613. When the handover destination network is not selected, or when the handover destination network is identical to the network that the digital camera 101 is currently connecting to, the smart device 102 can start the network information measurement and execute selection of the handover destination again. Accordingly, the smart device 102 can surely select an appropriate handover destination if the surrounding environment has changed when the handover request is received.

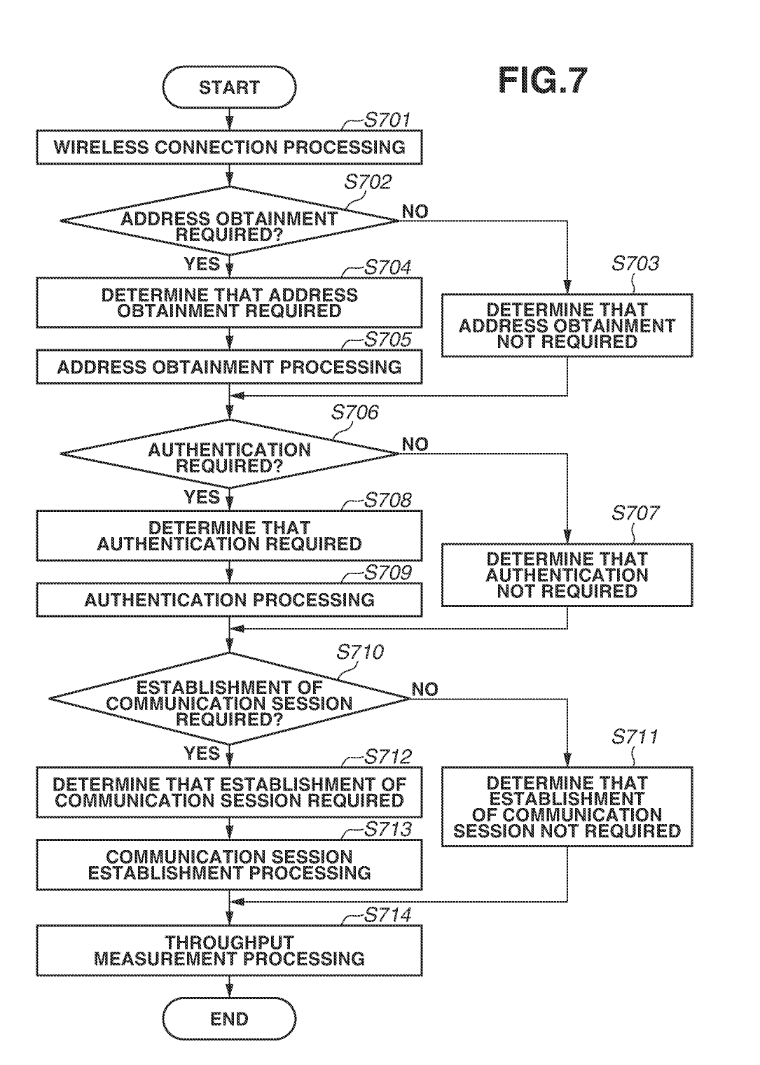

The network information measurement processing in step S607 is described below with reference to FIG. 7. When starting the network information measurement processing, in step S701, the smart device 102 first performs wireless connection processing to the target network. In the case that the smart device 102 is connected to another network at that time point, the smart device 102 disconnects the wireless connection with that network and then performs the wireless connection processing to the target network. In addition, the smart device 102 can perform processing such as disconnection of the communication session between the server 104 and release of an address being used before disconnecting the wireless connection with the currently connected network based on the network information of the relevant network. Next, in step S702, the smart device 102 determines whether the address obtainment processing is required to be executed. The smart device 102 can determine whether the address obtainment processing is required to be executed by transmitting an address use request signal including an address obtained at that time point and determining whether an address use permission response to the request is received. For example, the smart device 102 can execute the address obtainment processing and determine whether the address is identical to the preciously obtained address, or determine whether the identifier information is identical to that of an address allocation source apparatus.

When the address obtainment processing is required to be executed (YES in step S702), in step S704, the smart device 102 determines to store information requiring address obtainment as the network information, in step S705, executes the address obtainment processing, and advances the processing to step S706. When the address obtainment processing is not required to be executed (NO in step S702), in step S703, the smart device 102 determines to store information not requiring address obtainment as the network information and advances the processing to step S706. In step S706, the smart device 102 determines whether the authentication processing is required to be executed. When the authentication processing is required to be executed (YES in step S706), in step S708, the smart device 102 determines to store information requiring authentication as the network information, in step S709, executes the authentication processing, and advances the processing to step S710. If the authentication processing is not required to be executed (NO in step S706), in step S707, the smart device 102 determines to store information not requiring authentication as the network information and advances the processing to step S710. In step S710, the smart device 102 determines whether the communication session establishment processing is required to be executed. The smart device 102 can determine that the communication session establishment processing is required to be executed, for example, when it is determined that address obtainment or authentication is required based on necessity of address obtainment and necessity of authentication. However, the smart device 102 can determine, without being limited to the above-described process, that the communication session establishment processing is required to be executed. For example, when a communication protocol to be used is a protocol requiring re-establishment of the communication session for each handover. When the communication session establishment processing is required to be executed (YES in step S710), in step S712, the smart device 102 determines to store information requiring establishment of the communication session as the network information, and, in step S713, executes the communication session establishment processing. Subsequently, the smart device 102 advances the processing to step S714. When the communication session establishment processing is not required to be executed (NO in step S710), in step S711, the smart device 102 determines to store information not requiring establishment of the communication session as the network information, and advances the processing to step S714. In step S714, the smart device 102 performs throughput measurement processing. For example, the smart device 102 can transmit arbitrary dummy data to the server 104 using the communication session already established and measure a throughput from a size of the dummy data and a time required to transmission. The throughput can be measured using another arbitrary method. The smart device 102 executes the throughput measurement processing and then terminates the present processing.

As described above, according to the present processing example, the smart device 102 transmits the network information corresponding to the measurement of the actual environment to the digital camera 101. Accordingly, the digital camera 101 can accurately estimate required times to complete the communication when switching the connection destination and when not.

### (Example of Processing Executed in Wireless Communication System)

Flows of processing executed in the wireless communication system are described below by assuming some situations.

### ((First Processing Example))

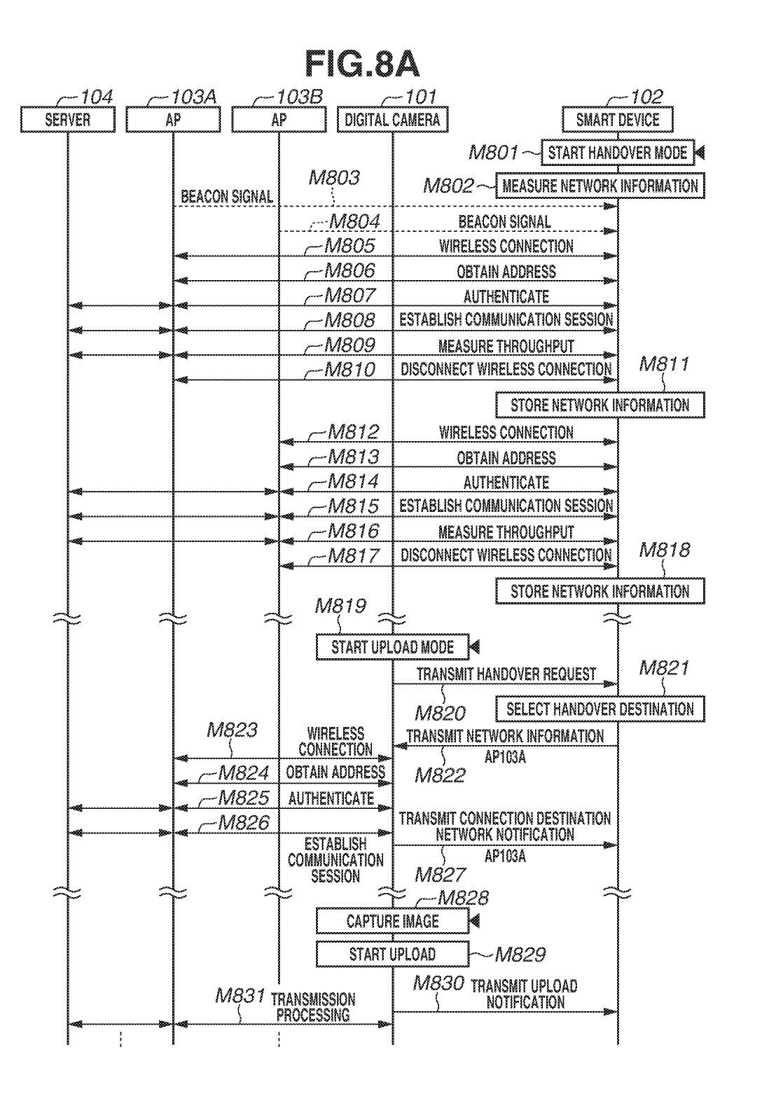

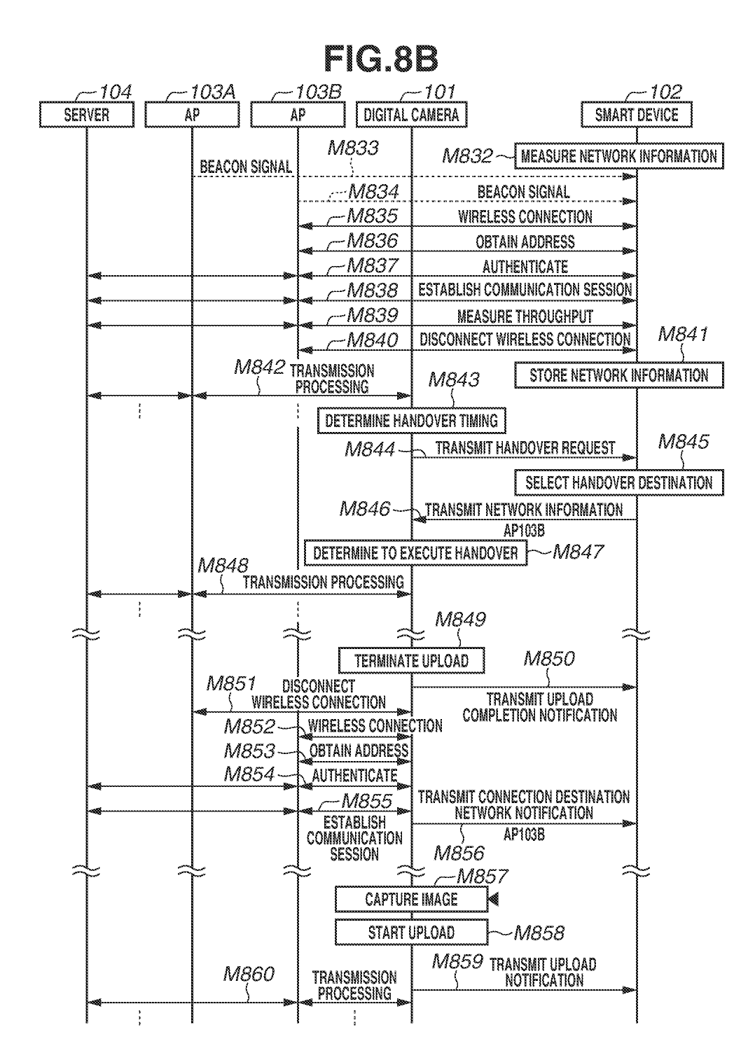

A first processing example is described with reference to FIGS. 8A and 8B. According to the present processing example, the digital camera 101 receives the network information regarding the AP 103A from the smart device 102 and connects to the AP 103A. The digital camera 101 receives the network information of the AP 103B from the smart device 102 and executes the handover execution determination. The digital camera 101 determines not to execute the handover at that time point and continues the upload processing of data via the AP 103A as a result of the handover execution determination, and switches the connection to the AP 103B, where completion of the upload processing is seen as a trigger. According to the present processing example, a network configuration is adopted where address information is managed by each AP. In other words, each network according to the present processing example requires address obtainment, authentication, and establishment of the communication session every time when executing the handover.

When a user starts up an application in the smart device 102 to start an operation in the handover mode, accordingly in M801, the smart device 102 starts an operation in the handover mode. The smart device 102 that has not received the handover request from the digital camera 101 (NO in step S601) and has never executed the network information measurement at this point, starts the network information measurement (in M802 and YES in step S602). When starting the network information measurement, in step S603, the smart device 102 executes scanning of the surrounding network to measure the network information of the handover destination candidate network of the digital camera 101. In M803 and M804, the smart device 102 detects beacons transmitted from the APs 103A and 103B by scanning, and performs the network information measurement on the APs 103A and 103B.

In M805 and step S701, the smart device 102 first establishes the wireless connection between the AP 103A to measure the network information of the AP 103A. In M806, the smart device 102 determines that the address obtainment is required and executes the address obtainment processing between the AP 103A (YES in step S702, and steps S704 and S705). Then, in M807, the smart device 102 determines that the authentication is required and executes the authentication processing between the server 104 (YES in step S706 and steps S708 and S709). In M808, the smart device 102 determines that the establishment of the communication session is required and executes the communication session establishment processing between the server 104 (YES in S710 and steps S712 and S713). In M809 and step S714, the smart device 102 measures the throughput by transmitting arbitrary dummy data, in M810, disconnects the wireless connection between the AP 103A after completing the measurement, and, in M811 and step S608, stores the network information of the AP 103A. Similarly, in M812 to M818, the smart device 102 measures and stores the network information of the AP 103B. The processing in M812 to M818 is similar to that in M805 to M811, so the detailed description thereof is omitted.

In response, the user performs a button operation or menu selection on the digital camera 101 to start an operation in the upload mode, and in M819, the digital camera 101 starts an operation in the upload mode. The digital camera 101 is not connected to the wireless LAN at this point, determines to establish connection (as the handover timing) (YES in step S419), and, in M820 and step S420, transmits the handover request to the smart device 102. In this regard, the digital camera 101 does not execute processing for switching the connecting network, so that the processing in this step is not strictly the handover, and thus a message different from the handover request can be transmitted. If any message is used, it is sufficient for the digital camera 101 to request information of the connection destination network from the smart device 102. When the handover request is received (YES in step S601), in M821 and step S609, the smart device 102 selects the handover destination AP (network). In this step, the smart device 102 selects the AP 103A as the connection destination AP since it is, for example, a network with the highest throughput. The smart device 102 has not received the connection destination network notification from the digital camera 101 and thus determines that the digital camera 101 is not connected to the network. In other words, since the digital camera 101 is not currently connected to the AP 103A (NO in step S611), in M822 and step S612, the smart device 102 transmits the network information of the AP 103A to the digital camera 101. The upload target image data does not exist at this point (NO in step S401), thus when receiving the network information (YES in step S415), the digital camera 101 executes connection processing to the AP 103A indicated by the received information (in step S416). In M823, the digital camera 101 establishes the wireless connection between the AP 103A, in M824, performs the address obtainment processing between the AP 103A, and performs the authentication processing in M825 and the communication session establishment processing in M826 between the server 104. When completing the connection processing between the AP 103A, in M827 and step S417, the digital camera 101 transmits the connection destination network notification to the smart device 102. The digital camera 101 causes the smart device 102 to select the connection destination network when starting the upload mode, but can execute the selection by itself. For example, the digital camera 101 itself searches for the surrounding network without transmitting the handover request to the smart device 102 and selects a network with the strongest radio field intensity from among the detected networks. The digital camera 101 does not connect to the wireless LAN when starting the upload mode, so that the throughput is not affected if the digital camera 101 itself searches for the network.

Subsequently, in M828, when a user performs image capturing operation using the digital camera 101, in M829, the digital camera 101 starts upload of the captured image data (YES in step S401). In response to a start of upload of the image data, in M830 and step S402, the digital camera 101 transmits the upload start notification to the smart device 102, and in M831 and step S408, performs the transmission processing via the AP 103A currently connected to.

When a predetermined time period elapsed from the previous network information measurement, in M832, the smart device 102 re-executes the network information measurement (YES in step S602). In M833 and M834, the smart device 102 detects the APs 103A and 103B based on beacons transmitted from these APs. In the detected AP 103A and AP 103B, the AP 103A is the network to which the digital camera 101 is uploading the image data (YES in step S604). Thus, the smart device 102 omits the network information measurement processing. The smart device 102 measures the network information of the AP 103B. Processing in M835 to M841 is similar to that in M812 to M818, so that the description thereof is omitted.

In M842 and step S408, the digital camera 101 transmits the image data, and when transmission of one image is completed (YES in step S409), in M843 and step S410, the digital camera 101 performs the handover timing determination. The digital camera 101 determines that it is the handover timing (YES in step S411) based on that the data transmission throughput to the server 104 via the AP 103A is less than or equal to the threshold value and the like. In this case, in M844 and step S412, the digital camera 101 transmits the handover request to the smart device 102. When receiving the handover request (YES in step S601), in M845 and step S609, the smart device 102 selects the handover destination AP (network). In this step, the smart device 102 selects the AP 103B as the handover destination AP since it is the network with the highest throughput. At this point, the smart device 102 already received the connection destination network notification from the digital camera 101. However, the network 107A is different from the network 107B selected as the handover destination (NO in step S611). Thus, in M846 and step S612, the smart device 102 transmits the network information of the AP 103B to the digital camera 101. The digital camera 101 can continue the transmission processing during the processing in M843 to M846. Accordingly, the digital camera 101 can shorten an interruption time of the communication with the AP 103A and suppress deterioration of the wireless communication efficiency.

When receiving the network information (YES in step S403), in M847 and step S404, the digital camera 101 performs the handover execution determination. In this step, the digital camera 101 determines that address obtainment, authentication, and establishment of the communication session are required when executing the handover, and the required time in the continuation case is less than the required time in the switching case (NO in step S509). In this case, in step S511, the digital camera 101 reserves the handover without performing the handover at this point, and in M848 and step S408, continues the transmission processing. In M849, when upload of all the upload target image data pieces is completed, in M850 and step S413, the digital camera 101 transmits the upload completion notification to the smart device 102. At that time, the upload target image data does not exist (NO in step S401), and the handover is reserved (YES in step S414), so that, in step S416, the digital camera 101 starts the handover processing. When starting the handover processing, in M851, the digital camera 101 disconnects the wireless connection with the AP 103A currently connected to, and, in M852, establishes the wireless connection with the AP 103B. In M853, the digital camera 101 performs the address obtainment processing between the AP 103B and performs the authentication processing in M854 and the communication session establishment processing in M855 between the server 104. When completing the handover processing to the AP 103B, in M856 and step S417, the digital camera 101 transmits the connection destination network notification to the smart device 102. Subsequently, in M857, when the user performs an image capturing operation on the digital camera 101, in M858, the digital camera 101 starts the upload processing of the captured image data (YES in step S401). When starting the upload processing, in M859 and step S402, the digital camera 101 transmits the upload start notification to the smart device 102, and, in M860 and step S408, transmits the image data to the server 104 via the AP 103B currently connected to.

As described above, according to the present processing example, the digital camera 101 obtains the network information corresponding to the measurement by the smart device 102, and thus can accurately estimate required times to complete the communication when switching the connection destination and when not. In addition, when upload of data is in the middle of processing, the digital camera 101 continues the upload processing without immediately executing the handover as a result of determination based on the network information received from the smart device 102. As described above, the digital camera 101 can timely and efficiently perform the handover in response to an accurate estimated result of the required time based on the information obtained from the smart device 102. In addition, the digital camera 101 does not need to interrupt the communication with the AP 103A to obtain the network information, and thus the wireless communication efficiency can be prevented from being deteriorated.

According to the present processing example, the digital camera 101 immediately starts the handover processing when the handover is reserved. However, the digital camera 101 can determine whether to start the handover processing based on an arbitrary condition. For example, the digital camera 101 can determine that the surrounding network is highly likely to be changed when a certain length of time has elapsed based on an elapsed time from when the handover is reserved and perform processing for not starting the handover processing and the like. At that time, the digital camera 101 can transmit the handover request again to the smart device 102. Accordingly, the digital camera 101 can perform the handover to a more appropriate AP in response to the change in the surrounding network.

### ((Second Processing Example))

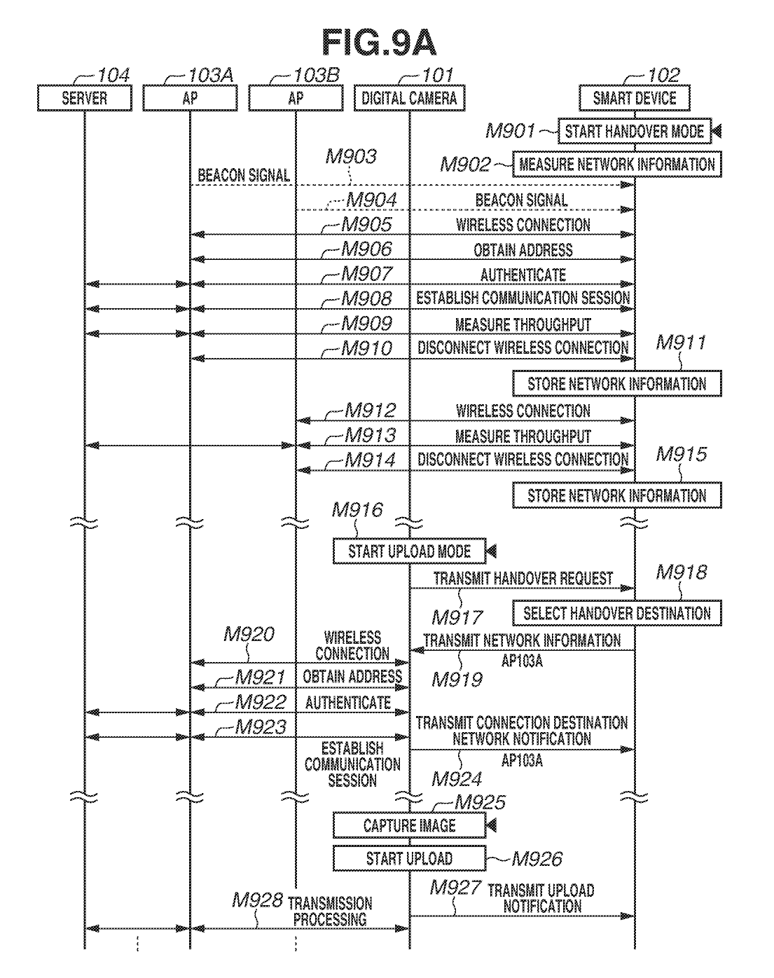

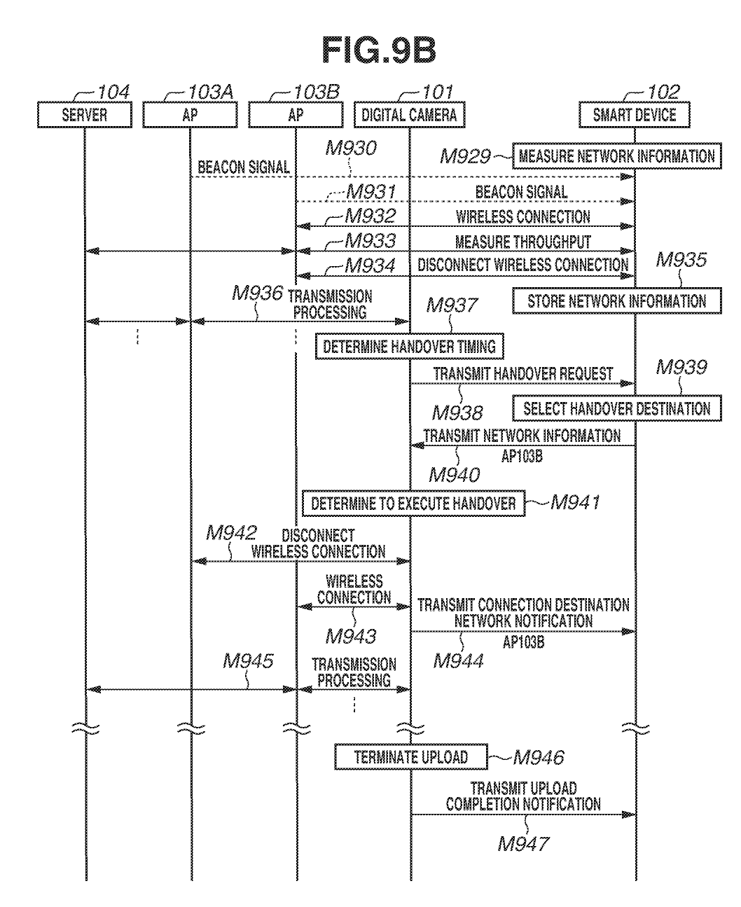

Next, a second processing example is described with reference to FIGS. 9A and 9B. According to the present processing example, the digital camera 101 also receives the network information regarding the AP 103A from the smart device 102 and connects to the AP 103A. The digital camera 101 receives the network information of the AP 103B from the smart device 102 and executes the handover execution determination. The digital camera 101 determines to execute the handover at that time point as a result of the handover execution determination, switches connection to the AP 103B, and resumes the upload processing of the data. According to the present processing example, the network configuration in which the address information is managed in the server 104 is used. In other words, according to the present processing example, when the handover is executed from a first network to a second network, address obtainment, authentication, and establishment of the communication session are not necessary.

Processing in M901 to M912 is similar to that in M801 to M812, so that the description thereof is omitted. In M906 to M908, address obtainment, authentication, and establishment of the communication session have been already executed, so that in M913 and step S714, the smart device 102 measures the throughput between the server 104 via the AP 103B without performing the relevant processing. Subsequently, in M914 to M928, the digital camera 101 starts upload of data by connecting to the AP 103A, transmits the connection destination network notification and the upload start notification to the smart device 102, and transmits the captured image data to the server 104 at that time point. The series of the processing is similar to that in M817 to M831, so that the detailed description thereof is omitted.

When a predetermined time period elapsed from the previous network information measurement, in M929, the smart device 102 re-executes the network information measurement (YES in step S602). In M930 and M931, the smart device 102 detects the APs 103A and 103B based on beacons transmitted from these APs. In the detected AP 103A and AP 103B, the AP 103A is the network to which the digital camera 101 is uploading the image data (YES in step S604). Thus, the smart device 102 omits the network information measurement processing. The smart device 102 measures the network information of the AP 103B. Processing in M932 to M935 is similar to that in M912 to M915, so that the description thereof is omitted. Processing in M936 to M940 is similar to that in M842 to M846, so that the description thereof is also omitted. In M941 and step S404, the digital camera 101 performs the handover execution determination based on the network information obtained in M940. In this step, the digital camera 101 determines that address obtainment, authentication, and establishment of the communication session are not necessary when executing the handover, and the required time in the switching case is less than the required time in the continuation case (NO in step S509). In this case, in step S416, the digital camera 101 suspends the transmission processing and starts the handover processing. When starting the handover processing, in M942, the digital camera 101 disconnects the wireless connection between the AP 103A currently connected to and, in M943, establishes the wireless connection between the AP 103B. The digital camera 101 completes the processing for address obtainment, authentication, and establishment of the communication session in M921 to M923, and, in M944 and step S407, transmits the connection destination network notification to the smart device 102 by omitting the relevant processing. When transmitting the connection destination network notification to the smart device 102, in M945 and step S408, the digital camera 101 resumes transmission of remaining data via the handover destination AP 103B. Processing in M946 and M947 is similar to that in M849 and M850, so that the description thereof is omitted.

As described above, according to the present processing example, the digital camera 101 obtains the network information corresponding to the measurement by the smart device 102, and thus can accurately estimate required times to complete the communication when switching the connection destination and when not. In addition, when upload of data is in the middle of processing, the digital camera 101 executes the handover at that time point and resumes the upload of data as a result of determination based on the network information received from the smart device 102. As described above, the digital camera 101 can timely and efficiently perform the handover in response to an accurate estimated result of the required time based on the information obtained from the smart device 102. In addition, the digital camera 101 does not need to interrupt the communication with the AP 103A to obtain the network information, and thus the wireless communication efficiency can be prevented from being deteriorated.

According to the present processing example, the address information is managed in the server 104. However, the address information can be managed in a different server. For example, a server for managing the address information can exist between the backbone network 108 and the APs 103A and 103B.

According to the each processing example, the digital camera 101 determines the handover timing at each time transmission of one image is completed. However, the handover timing can be determined in the middle of the transmission. For example, one image can be divided into packets with a certain size, and the handover timing determination can be performed when transmission of each packet is completed. Accordingly, the digital camera 101 can immediately transmit the handover request, for example, in a situation in which the data transmission throughput via the currently connecting network sharply drops and thus can execute the handover at an earlier timing.

According to the each processing example, the smart device 102 regularly performs the network information measurement, but can perform the network information measurement at a different timing. For example, the smart device 102 can measure the network information upon receipt of the handover request from the digital camera 101. Accordingly, it is sufficient for the smart device 102 to perform the network information measurement only at a timing when the digital camera 101 intends to execute the handover, and thus a battery consumption can be further suppressed.

According to the each processing example, the smart device 102 establishes the communication session with the server 104 for measuring the network information, but can establish the communication session between a different server rather than the server 104. For example, the smart device 102 can establish the communication session between a different server connected to the same backbone network as the server 104 and perform the network information measurement. Accordingly, an increase in a communication load of the server 104 can be suppressed, and degradation of throughput in the communication with the digital camera 101 can be reduced.

The above-described digital camera and smart device are examples, and other apparatuses can be used. For example, the digital camera can be replaced with an arbitrary communication apparatus that obtains information for controlling communication in a first communication scheme, such as the wireless LAN or an operation in an apparatus using a second communication scheme, such as Bluetooth Low Energy. In addition, the smart device can be an arbitrary communication apparatus that can transmit information used for controlling communication in the first communication scheme, such as the wireless LAN of a partner apparatus, or an operation in the apparatus using the second communication scheme, such as Bluetooth Low Energy. The scope of the present disclosure includes arbitrary communication apparatuses executing the above-described processing and processing that is at least partly changed based on above-described processing.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-009775, filed Jan. 23, 2017, which is hereby incorporated by reference herein in its entirety.

What is claimed is:

1. A communication apparatus comprising:
an obtainment unit configured to obtain information regarding a network measured by another apparatus from the another apparatus;
a connection unit configured to connect to the network related to the information based on the information regarding the network obtained by the obtainment unit;
a communication unit configured to perform communication of data via the connected network; and
a control unit configured to, in a case where the obtainment unit obtains information regarding a second network while the communication unit performs communication of data via a first network, control switching of connection to the connection unit based on a first time length required to complete the communication in a case where connection to the first network is continued and a second time length required to complete the communication in a case where connection is switched to the second network.

2. The communication apparatus according to claim 1, wherein in a case where the first time length is longer than the second time length, the control unit performs control to switch connection from the first network to the second network if the communication unit is performing communication of data via the first network.

3. The communication apparatus according to claim 1, wherein in a case where the first time length is shorter than the second time length, the control unit performs control not to switch connection from the first network to the second network while the communication unit performs communication of data via the first network.

4. The communication apparatus according to claim 3, wherein the control unit performs control to switch communication from the first network to the second network after the communication unit completes communication of data via the first network.

5. The communication apparatus according to claim 1, wherein in a case there the obtainment unit obtains the information regarding the second network while the communication unit does not perform communication of data via the first network, the control unit performs control to switch connection from the first network to the second network regardless of the first time length and the second time length.

6. The communication apparatus according to claim 1, further comprising a calculation unit configured to calculate the first time length based on a size of data of which communication via the first network is not completed in data pieces communicated by the communication unit and communication quality of communication via the first network by the communication unit.

7. The communication apparatus according to claim 6, wherein the calculation unit further calculates the second time length based on at least the information regarding the second network.

8. The communication apparatus according to claim 7, wherein the calculation unit calculates the second time length based on communication quality of communication via the second network included in the information regarding the second network and the size.

9. The communication apparatus according to claim 7, wherein in a case where the information regarding the second network requires re-communication of data communicated via the first network when the second network is connected, the calculation unit calculates the second time length based on a value obtained by adding a size of the data communicated to the size and communication quality of communication via the second network.

10. The communication apparatus according to claim 1, wherein the obtainment unit obtains information regarding a network using a second communication scheme different from a first communication scheme used by the connection unit.

11. The communication apparatus according to claim 1, wherein the information regarding the second network includes one or more of a throughput, radio field intensity, necessity of address obtainment, necessity of authentication, necessity of communication session establishment, a data rate, a delay time, a retransmission probability, a packet loss rate, and a number of connecting terminals of the second network.

12. A communication apparatus comprising:
a detection unit configured to detect a network;
an obtainment unit configured to obtain information regarding the detected network;
a notification unit configured to notify another apparatus of the information; and
a control unit configured to control the obtainment unit to obtain information regarding a second network instead of a first network while the another apparatus performs communication via the first network.

13. The communication apparatus according to claim 12, wherein the obtainment unit obtains information regarding a network in which a radio wave is received at an intensity greater than or equal to a predetermined value.

14. The communication apparatus according to claim 12, wherein
the obtainment unit connects to the detected network and obtains the information by performing a measurement regarding the detected network, and
the control unit controls the obtainment unit not to connect to the first network while the another apparatus performs communication via the first network.

15. The communication apparatus according to claim 12, further comprising a reception unit configured to receive a notification whether the another apparatus is performing communication via the first network from the another apparatus.

16. The communication apparatus according to claim 12, wherein the notification unit notifies the another apparatus of the information using a second communication scheme different from a first communication scheme used by the network, the first network, and the second network.

17. The communication apparatus according to claim 16, wherein the first communication scheme is a communication wireless local area network communication scheme and the second communication scheme is a Bluetooth® communication scheme.

18. A method for controlling a communication apparatus, the method comprising:
obtaining information regarding a network measured by another apparatus from the another apparatus;
connecting to the network related to the information based on the information regarding the network;
performing communication of data via the connected network;
obtaining information regarding a second network while the communication apparatus performs communication of data via a first network; and
controlling switching of connection based on a first time length required to complete the communication in a case where connection to the first network is continued and a second time length required to complete the communication in a case where connection is switched to the second network.

19. A method for controlling a communication apparatus, the method comprising:
detecting a network;
obtaining information regarding the detected network;
notifying another apparatus of the information; and
obtaining information regarding a second network instead of a first network while the another apparatus performs communication via the first network.

20. A computer-readable storage medium storing a program causing a communication apparatus to execute a method, the method comprising:
obtaining information regarding a network measured by another apparatus from the another apparatus;
connecting to the network related to the information based on the information regarding the network;
performing communication of data via the connected network;
obtaining information regarding a second network while the communication apparatus performs communication of data via a first network; and
controlling switching of connection based on a first time length required to complete the communication in a case where connection to the first network is continued and a second time length required to complete the communication in a case where connection is switched to the second network.
